(19) United States
(12) Patent Application Publication
(10) Pub. No.: US 2006/0186612 A1
(43) Pub. Date: Aug. 24, 2006

(54) Dust cover for automatic chuck

(76) Inventor: Daniel Puzio, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/357,819

(22) Filed: Feb. 17, 2006

Related U.S. Application Data
(60) Provisional application No. 60/654,860, filed on Feb. 18, 2005.
(60) Provisional application No. 60/654,852, filed on Feb. 18, 2005.

(51) Int. Cl. B23B 31/12

(52) U.S. Cl. 279/62

(57) ABSTRACT

The jaw mechanism has a plurality of jaw members or elements which are slidably disposed within corresponding channels defined in a rotatable body. A threaded body which is configured to be rotated either in a first or second direction is rotatably disposed about and engaged with the jaws. A thrust bearing assembly is configured to interface with the threaded body to rotate the threaded body to close the jaws when rotated. A dust cover is provided to cover the jaw mechanism. A grommet is provided which is annularly disposed about the bit to restrict dust from entering through the chuck jaw elements.

### CROSS-REFERENCE TO RELATED APPLICATIONS

This application claims the benefit of U.S. Provisional Application No. 60/654,860, filed on Feb. 18, 2005 and U.S. Provisional Application No. 60/654,852 filed on Feb. 18, 2005. The disclosure of the above applications is incorporated herein by reference.

### FIELD OF THE INVENTION

The present invention relates to chucks and, particularly, to chucks having mechanisms configured to automatically engage a bit and, more particularly, to a duct cover for an automatic chuck.

### BACKGROUND OF THE INVENTION

Chuck members for tools have been developed which are configured to automatically engage and disengage drive or cutting elements or bits. One mechanism for engaging cutting bits utilizes a spring-loaded impact mechanism to rotate gripping teeth with respect to a threaded member relative to the rotating teeth to bring either into engagement or out of engagement with the cutting bit. Upon initialization by an operator, these impact mechanisms utilize forward and reverse drive forces from a motor to drive the jaw mechanism into and out of engagement with the drill bit. The operation of these chuck mechanisms are described in co-assigned U.S. Provisional Patent Application No. 60/654,852 by Gehret, et al., entitled “NON-SLIP REVERSE DEVICE FOR IMPACTING-TYPE CHUCK.

These chuck mechanisms are however greatly affected by the deleterious effects of dust which become trapped within the chuck. This dust, which often evolves from the use of a cutting tool held by the chuck, becomes entrapped within the lubricants in the chuck and significantly reduces the operating life of the chuck mechanism.

### SUMMARY OF THE INVENTION

To overcome the deficiencies of the prior art, a chuck mechanism is disclosed having a user initiated tightenable jaw mechanism covered with a dust cover. This mechanism has a plurality of engageable jaws that are coupled to a rotatable socket member. An impact assembly is configured to interface with the socket member to prevent rotation of the socket member relative to a tool body. Rotation of the jaws in a first direction with respect to the selectively engageable socket allows the interaction of the jaws with the fixed socket member to close the jaws. Likewise, the jaws open when they are rotated with respect to the selectively engageable socket in a second direction. The dust cover covers the chuck mechanism and defines a bit accepting aperture which is co-axial with an aperture defined by the jaws.

In another embodiment of the invention, an impact assembly for a user engageable chuck assembly is provided which is formed of an annular impact ring, a spring, and a spring bearing member. A mechanism is provided which is configured to position the spring at a first length when the jaws are rotated relative to the selectively engageable socket member in a first direction and a second length when the jaws are rotated with respect to the selectively engageable socket in a second direction. The variation of the spring length varies the force applied by the socket to the jaws. A dust cover is provided to cover the user initiated tightening chuck mechanism. The dust cover, which is non-rotatably fixed to a housing, defines a bit accepting aperture. A sealing grommet is optionally provided which is annularly disposed about the bit to least partially cover a portion of the jaw and at least partially covering the aperture.

### BRIEF DESCRIPTION OF THE DRAWINGS

The present invention will become more fully understood from the detailed description and the accompanying drawings, wherein:

FIGS. 1 and 2 represent tools utilizing the chuck dust cover according to the teachings of the prior art.

### DETAILED DESCRIPTION OF THE PREFERRED EMBODIMENTS

The following description of the preferred embodiments is merely exemplary in nature and is in no way intended to limit the invention, its application, or uses.

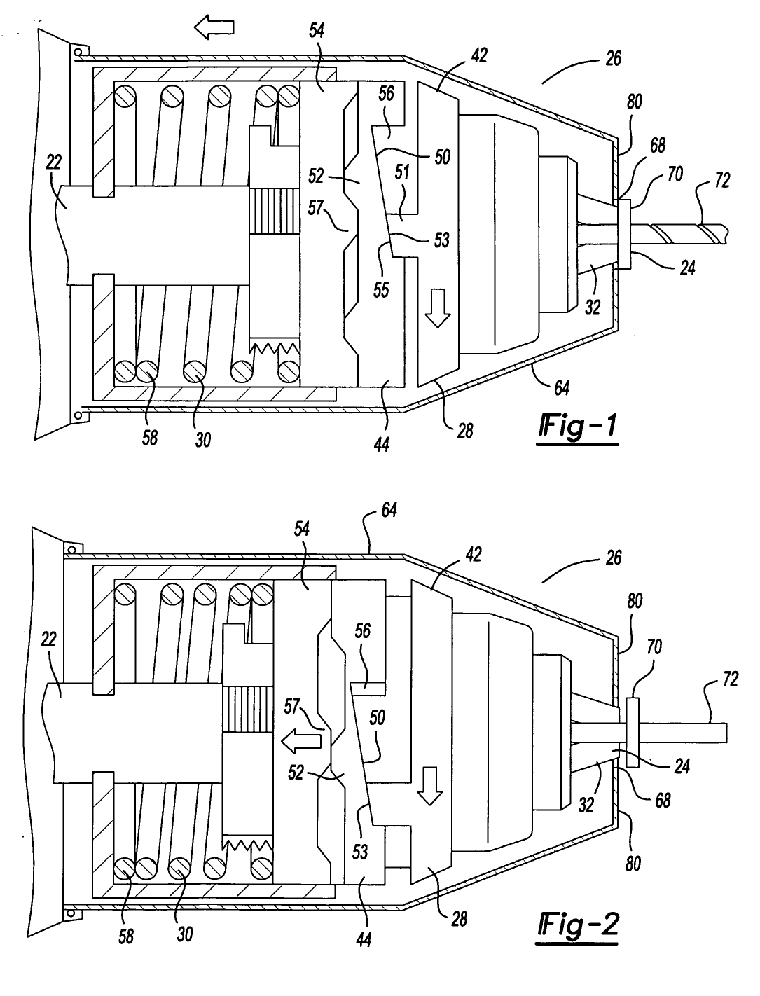

As best seen in FIG. 1, a jaw assembly 26 for a cutting or drive assembly is shown. The jaw assembly 26 has an associated dust cover 64 that is configured to reduce the amount of foreign debris which can be incorporated into the jaw assembly. The jaw assembly 26 can have a center bit accepting through bore 24 formed therein, while an associated spindle 22 (not shown) can have a plurality of angularly disposed jaw accepting guideways formed therethrough that intersect the center through bore 24. The rearward section of the spindle 22 can have a threaded hole, which is adapted to threadingly engage an output spindle of a power tool (not shown).

The jaw assembly 26 has a plurality of jaw elements 32 which are movable from a first disengaged to a second engaged position. A selectively engaged socket member 28 is provided that is configured to drive the jaw elements 32 from the disengaged to the engaged position. An impact assembly 30 is configured to apply anti-rotational forces to the socket member 28, which normally rotates with the spindle 22. The impact assembly 30 has an impact ring, a spring, and a spring support member. The impact assembly 30 is configured to apply a first axial force and a first torsional force onto the socket member 28 when the impact assembly 30 is engaged and the socket member 28 is held fixed with respect to the jaw elements 32 which are being rotated in a first direction. Additionally, the impact assembly 30 is configured to apply a second axial and torsional force when the impact assembly 30 is engaged and when the jaw assembly 26 is rotated with respect to the selectively engageable socket member 28 in a second direction. A dust cover 64 is configured to cover the self-tightening mechanism. The dust cover 64 can be rotatably or non-rotatably coupled to a housing of the tool.

The socket member or assembly 28 is annularly disposed about the jaw elements 32. The socket 28 preferably defines an interior threaded bore, which is configured to interface with a threaded drive surface of the jaw elements 32. Under normal operation of the tool, the socket 28 co-rotates with the jaw elements 32 and therefore does not move relative to the jaw elements 32. To tighten or loosen the jaw elements 32, the impact assembly 30 is engaged with the jaw assembly 26 is rotated relative to the intermittently fixed socket 28.

The relative rotation of the jaw assembly 26 with the fixed socket causes the jaw elements 32 to move together though the guideways in the spindle 22 when the jaw assembly 26 is rotated in a first or tightening direction with respect to the intermittently engageable socket 28. Similarly, the chuck is disengaged when the jaw assembly 26 is rotated in a second or loosening direction relative to the socket 28. The socket 28 can be formed of two rings (42 and 44). The first ring 42 having the interior threaded surface (not shown) and a ramp interface surface 53. The second ring 44 has a ramped surface 50 configured to interface with the ramp interface surface 48 of the first ring 42 and a plurality of engagement teeth 52.

Upon engagement of the impact assembly 30 and rotation of the jaw assembly 26 in the second or loosening direction, the threaded engagement between the jaws 32 and first ring 42 will initially cause first ring 42 to also rotate in the second direction. Second ring 44, however, will be restrained from rotation by the engagement between teeth 52 and teeth 57. Thus, first ring 42 will rotate relative to second ring 44 and ramped leg 51 will slide into the shallow end 55 of ramped surface 50. When ramped legs 51 are in the shallow end of ramped surface 50 there can be no further relative rotation between first ring 42 and second ring 44. At that point, impact ring 54 effectively engages first ring 42 via teeth 52 and 57 and via second ring 44. Since first ring 42 is then prevented from rotating, there will be relative rotation between first ring 42 and jaw assembly 26 causing jaws 32 to move outward as described.

As seen in FIG. 2, when a predetermined amount of torque is thereafter applied to the spindle 22, the socket 28 will begin to rotate with the spindle 22, causing the socket teeth 52 to ride over the ring teeth 57 and urge the impacting ring 54 in a rearward direction away from the threaded socket 28. Since the spring 58 biases the impacting ring 54 forwardly, the socket teeth 52 will periodically strike the ring teeth 57 as the threaded socket 28 rotates. The impact of the socket teeth 52 and the first ring teeth 57 will generate a torque that is applied to the threaded socket 28. This tends to further urge the threaded socket 28 against the jaw members 32. This results in the spring 58 applying a larger force to the impact ring 54 of the impact assembly 30. This, in turn, results in an increased loosening torque applied to the jaw elements 32 and bit interface when the jaw elements 32 are disengaging a bit.

During chucking, continued rotation of the jaw assembly 26 in the first or tightening direction will cause the rotationally coupled rings 42 and 44 to induce the reciprocating and impacting movement of impact ring 54 as previously described. The sloped interface 50 allows the interface ring 44 to move axially away from the spring bearing element 60 thus allowing the spring 58 to lengthen. This results in the spring 58 applying a smaller force to the impact ring 54 of the impact assembly 30. This in turn results in a reduced tightening torque applied to the jaw elements 32 and bit interface when the jaw elements are engaging a bit.

During unchucking of a drill bit, upon rotation of the jaw assembly 26 in the second or loosening direction, the threaded engagement between the jaws 32 and first ring 42 will initially cause first ring 42 to also rotate in the second direction. Second ring 44, however, will be restrained from rotation by the engagement between teeth 52 and teeth 57. Thus, first ring 42 will rotate relative to second ring 44 and ramped leg 51 will slide into the deep end 56 of ramped surface 50. When ramped legs 51 are in the deep end of ramped surface 50 there can be no further relative rotation between first ring 42 and second ring 44. At that point impact ring 54 effectively engages first ring 42 via teeth 52 and 57 and via second ring 44. The socket 28 has a first thickness when rotated in the first direction and a second thickness when rotated in the second direction.

Continued rotation of the jaw assembly 26 in the second or loosening direction will cause rotationally interlocked first ring 42 and second ring 44 to initially rotate along with the jaw assembly 26. Rotation of second ring 44 will cause the socket teeth 52 to ride over the ring teeth 57 and urge the impacting ring 54 in a rearward direction away from the threaded socket 28. Since the spring 58 biases the impacting ring 54 forwardly, the socket teeth 52 will periodically strike the ring teeth 57 as the threaded socket 28 rotates. The impact of the socket teeth 52 and the ring teeth 57 will generate a torque that will eventually overcome the static friction between the first ring 42 and jaws 32, at which point the first ring will break free of the jaws. Further rotation of the jaw assembly 26 will result in relative rotation between jaws 32 and first ring 42, since rotation of first ring 42 is resisted via the interlocked second ring 44, teeth 52 and 57, and impact ring 54. The continued relative rotation between rotating jaws 32 and nonrotating first ring 42 will cause the jaws to move axially rearward and outward, thus releasing the bit from the chuck. Advantageously in this embodiment, since second ring 44 was forced rearward when ramped leg 51 moved to the deep end 56 of ramped surface 50, spring 58 is compressed relative to its condition during chucking/tightening as described above. This results in the spring 58 applying a larger force to the impact ring 54 of the impact assembly 30 during unchucking. This in turn results in an increased loosening torque applied to the jaw elements 32 and bit interface when the jaw elements 32 are disengaging a bit.

The dust cover 64 is provided which encapsulates the chuck mechanism 20. The dust cover 64, which is rotatably or non-rotatably coupled a body 66 of the tool, defines a bit accepting aperture 68. As can be seen in FIGS. 1 and 2, the jaw elements 32 are positioned immediately adjacent the aperture 68. The dust cover 64 has a generally cylindrical body and an end plate.

To restrict the flow of dust into and through the aperture 68, a grommet member 70 is optionally provided annularly disposed about the bit 72. Additionally, the grommet member 70 on the bit 72 is positioned adjacent a proximal surface 80 of the dust cover 64. In this regard, the grommet member 70 is positioned less than about 3 mm and preferably about 1 mm from the end plate of the dust cover 64. The grommet 70 is additionally optionally positioned adjacent the jaw elements. The bit 72, the grommet 70 and the jaw elements rotate together.

The description of the invention is merely exemplary in nature and, thus, variations that do not depart from the gist of the invention are intended to be within the scope of the invention. For example, it is envisioned the dust cover can be utilized with any automatic chuck mechanisms such as those described in U.S. Provisional Application No. 60/654,852. Such variations are not to be regarded as a departure from the spirit and scope of the invention.

What is claimed is:

1. A tool comprising:
a drive;
a self-tightening chuck assembly comprising,
a jaw assembly having a plurality of jaw elements, the jaw elements movable from a first disengaged to an engaged position;
a drive member configured to drive the jaw elements from the disengaged to engaged position;
an impact assembly configured to apply rotational forces to the drive member; and
a dust cover configured to cover the self-tightening chuck assembly.

2. The tool according to claim 1 further comprising a bit disposed within the jaw assembly and a grommet annularly disposed about the bit.

3. The tool according to claim 1 wherein the drive member is a threaded socket member configured to drive the jaw elements from the disengaged to the engaged position.

4. The tool according to claim 1 wherein the dust cover defines a generally cylindrical body and an end plate defining an aperture.

5. The tool according to claim 4 further comprising a tool bit disposed within the aperture.

6. The tool according to claim 5 wherein the tool bit comprises a rubber grommet disposed less than about 3 mm from the dust cover aperture.

7. A self-tightening chuck assembly comprising:
a jaw assembly having a plurality of jaw elements, the jaw elements movable from a first disengaged to an engaged position;
an intermittently engageable socket member configured to drive the jaw elements from the disengaged to the engaged position;
an impact assembly configured to intermittently apply anti-rotational forces to the socket member, the impact assembly having an impact ring, a spring, and a spring support member, the impact assembly configured to apply a first axial force onto the socket member when the jaw assembly is rotated with respect to the socket member in a first direction, and a second axial force onto the socket member when the jaw assembly is rotated with respect to the socket member in a second direction; and
a dust cover configured to cover a portion of the jaw assembly.

8. The chuck assembly according to claim 7 wherein the spring has a first compressed length when the socket member is engaged and the jaw assembly is rotated in the first direction and a second length when the socket member is engaged and the jaw assembly is rotated in the second direction.

9. The chuck assembly according to claim 7 wherein the socket member is formed of first and second members, said first and second members being rotatable with respect to each other from a first to a second position, said socket member having a first thickness when rotated in the first direction and a second thickness when rotated in the second direction.

10. The chuck assembly according to claim 7 further comprising a bit disposed within the jaw assembly and a grommet annularly disposed about the bit.

11. The chuck assembly according to claim 7 wherein the dust cover defines a generally cylindrical body and an end plate defining an aperture.

12. The chuck assembly according to claim 7 further comprising a tool bit disposed within the aperture.

13. The chuck assembly according to claim 12 wherein the tool bit comprises a rubber grommet disposed less than about 3 mm from the dust cover aperture.

14. A drill chuck comprising:
a spindle that is adapted to be coupled to a source of rotational power;
a plurality of jaw members slidably supported on the spindle;
a threaded socket disposed about the spindle and threadably engaged with at least one of the jaw members;
a spring disposed about the spindle;
an impacting structure being disposed about the spindle and being biased towards the threaded socket by the spring, the impacting structure including a ring having a first set of structure teeth configured to interact with a structure on the threaded sockets, wherein the ring is moveable from a first location to a second location, said spring having a first compressed length when the ring is in the first location; and
a dust cover configured to cover the impacting structure, said dust cover defines a generally closed body and an end portion defining an aperture, said body being non-rotatably coupled to a tool housing.

15. The drill chuck according to claim 14 wherein the spring applies a first axial force onto the impacting structure when the ring is in the first location and a second axial force when a ring is in a second location.

16. The drill chuck according to claim 14 further comprising a bit disposed between the jaw members and a grommet annularly disposed about the bit.

17. The drill chuck according to claim 14 wherein the dust cover defines a generally cylindrical body and an end plate defining an aperture.

18. The drill chuck according to claim 14 further comprising a tool bit disposed within the aperture.

19. The drill chuck according to claim 18 wherein the tool bit comprises a rubber grommet disposed less than about 3 mm from the dust cover aperture.
